(19) United States
(12) Patent Application Publication
(10) Pub. No.: US 2025/0047368 A1
(43) Pub. Date: Feb. 6, 2025

(54) METHOD FOR NEIGHBORING CELL MEASUREMENT, DEVICE, AND CHIP

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN); Xinlei YU, Dongguan (CN)

(21) Appl. No.: 18/922,830

(22) Filed: Oct. 22, 2024

Related U.S. Application Data
(63) Continuation of application No. PCT/CN2022/100381, filed on Jun. 22, 2022.

(51) Int. Cl. H04B 7/185; H04W 36/08

(52) U.S. Cl. CPC H04B 7/18519; H04W 36/083

(57) ABSTRACT

Provided is a method for neighboring cell measurement. The method is applicable to a terminal device, and the method includes: starting or performing measurement on a neighboring cell in response to the terminal device satisfying a neighboring cell measurement start condition; wherein the neighboring cell measurement start condition is related to first information and/or second information, the first information including information related to a distance and/or delay between the terminal device and a satellite, and the second information including information related to a measurement start time.

### CROSS-REFERENCE TO RELATED APPLICATION

This application is a continuation application of international application No. PCT/CN2022/100381, filed on Jun. 22, 2022, the entire content of which is incorporated herein by reference.

### TECHNICAL FIELD

The present disclosure relates to the field of communications, and in particular, relates to a method for neighboring cell measurement, a device, and a chip.

### BACKGROUND

When terminal devices perform cell reselection or cell handover, the terminal devices need to perform neighboring cell measurement to find suitable neighboring cells for selection. At present, further research is needed for neighboring cell measurement.

### SUMMARY

Embodiments of the present disclosure provide a method for neighboring cell measurement, a device, and a chip. The technical solutions are as follows.

According to some embodiments of the present disclosure, a method for neighboring cell measurement is provided. The method is applicable to a terminal device. The method includes:
starting or performing measurement on a neighboring cell in response to the terminal device satisfying a neighboring cell measurement start condition;
wherein the neighboring cell measurement start condition is related to first information and/or second information, the first information including information related to a distance and/or delay between the terminal device and a satellite, and the second information including information related to a measurement start time.

According to some embodiments of the present disclosure, a terminal device is provided. The terminal device includes a processor and a memory, wherein the memory stores at least one computer program, and the processor, when loading and executing the at least one computer program, is caused to perform the method for neighboring cell measurement.

According to some embodiments of the present disclosure, a chip is provided. The chip includes at least one programmable logic circuit and/or at least one program instruction, wherein the chip, when running, performs the method for neighboring cell measurement.

### BRIEF DESCRIPTION OF DRAWINGS

FIG. 1 is a schematic diagram of a satellite network architecture according to some embodiments of the present disclosure;

FIG. 2 is a schematic diagram of another satellite network architecture according to some embodiments of the present disclosure;

FIG. 3 is a flowchart of a method for neighboring cell measurement according to some embodiments of the present disclosure;

FIG. 4 is a schematic diagram of a positional relationship between a terminal device and a satellite according to some embodiments of the present disclosure;

FIG. 5 is a schematic diagram of starting a neighboring cell measurement based on time information according to some embodiments of the present disclosure;

FIG. 6 is a block diagram of an apparatus for neighboring cell measurement according to some embodiments of the present disclosure; and

FIG. 7 is a structural schematic diagram of a terminal device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The network architecture and the business scenarios described in the embodiments of the present disclosure are for the purpose of more clearly illustrating the technical solutions of the embodiments of the present disclosure, and do not constitute a limitation to the technical solutions according to the embodiments of the present disclosure. Those skilled in the art knows that, with the evolution of the network architecture and the appearance of new business scenarios, the technical solutions according to the embodiments of the present disclosure are equally applicable to similar technical problems.

At present, relevant standards organizations are studying the NTN technology, and the NTN technology generally uses satellite communication to provide communication services to terrestrial users. Compared to terrestrial cellular communication networks, satellite communications have many unique advantages. First, satellite communication is not limited by the user's location, for example, general terrestrial communication cannot cover the ocean, mountains, deserts and other regions where communication equipment cannot be set up or communication coverage is not provided due to the sparse population. While for satellite communication, because a satellite can cover a large area of the ground, and the satellites can move around the Earth in orbit, theoretically every corner of the Earth can be covered by satellite communication. Second, satellite communication has greater social value. Satellite communications can cover remote mountainous regions, poor and backward countries or regions at a lower cost, such that people in these regions can enjoy advanced voice communications and mobile Internet technology, which is conducive to narrowing the digital divide with developed regions and promoting the development of these regions. Then, satellite communication is far away, and the cost of communication does not increase significantly as the communication distance increases. Finally, satellite communication is highly stable and not subject to natural disasters.

Communication satellites are categorized based on orbital altitude as low Earth orbit (LEO) satellites, medium Earth orbit (MEO) satellites, geostationary Earth orbit (GEO) satellites, high elliptical orbit (HEO) satellites, high elliptical orbit (GEO) satellites, and the like. At present, the LEO satellites and the GEO satellites are mainly studied.

### LEO Satellites

The altitude of LEO satellite ranges from 500 km to 1500 km, and the corresponding orbital period is about 1.5 hours to 2 hours. The signal propagation delay of single-hop communication between users is generally less than 20 ms, and the maximum satellite visualization time is 20 minutes. The signal propagation distance is short, the link loss is small, and the transmit power requirement for user terminal device is not high.

### GEO Satellites

The orbital altitude of GEO satellite is 35786 km and the rotation period of GEO satellite around the Earth is 24 hours. The signal propagation delay of single-hop communication between users is generally 250 ms.

In order to ensure the coverage of the satellite and enhance the system capacity of the whole satellite communication system, the satellite uses multi-beam to cover the ground, and a satellite can form dozens or hundreds of beams to cover the ground. The satellite beam can cover the ground area with a diameter of dozens to hundreds of kilometers.

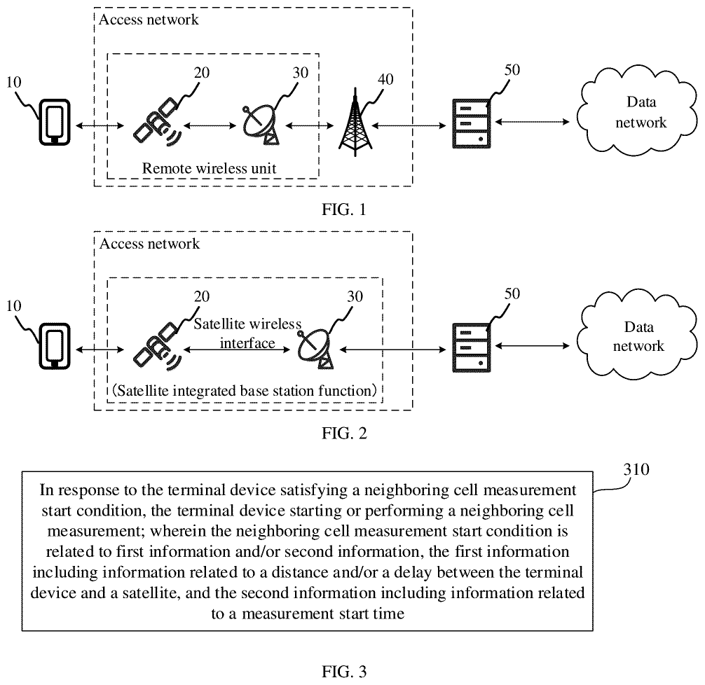

Referring to FIG. 1, FIG. 1 illustrates a schematic diagram of a satellite network architecture in which the communication satellites are transparent payload satellites. As shown in FIG. 1, the satellite network architecture includes a terminal device 10, a satellite 20, an NTN gateway 30, an access network device 40, and a core network device 50.

The terminal device 10 and the access network device 40 communicate with each other over an air interface (e.g., a Uu interface). In the architecture shown in FIG. 1, the access network equipment 40 is arranged on the ground, and upstream and downstream communications between the terminal device 10 and the access network equipment 40 are relayed and transmitted over the satellite 20 and the NTN gateway 30 (typically on the ground). Taking the uplink transmission as an example, the terminal device 10 transmits an uplink signal to the satellite 20, the satellite 20 forwards the uplink signal to the NTN gateway 30, the NTN gateway 30 forwards the uplink signal to the access network equipment 40, and the access network equipment 40 subsequently transmits the uplink signal to the core network equipment 50. Taking the downlink transmission as an example, the downlink signal from the core network equipment 50 is transmitted to the access network equipment 40, the access network equipment 40 transmits the downlink signal to the NTN gateway 30, the NTN gateway 30 forwards the downlink signal to the satellite 20, and the satellite 20 forwards the downlink signal to the terminal device 10.

Referring to FIG. 2, FIG. 2 illustrates a schematic diagram of another satellite network architecture in which the communication satellites are regenerative payload satellites. As shown in FIG. 2, the satellite network architecture includes a terminal device 10, a satellite 20, an NTN gateway 30, and a core network device 50.

In the architecture shown in FIG. 2, the functions of the access network equipment 40 are integrated on the satellite 20, i.e., the satellite 20 has the functions of the access network equipment 40. The communication between the terminal device 10 and the satellite 20 is performed over an air interface (e.g., a Uu interface). The communication between the satellite 20 and the NTN gateway 30 (typically on the ground) is performed over a satellite radio interface (SRI).

In the architecture shown in FIG. 2, taking the uplink transmission as an example, the terminal device 10 transmits an uplink signal to the satellite 20, the satellite 20 forwards the uplink signal to the NTN gateway 30, and the NTN gateway 30 transmits the uplink signal to the core network equipment 50. Taking the downlink transmission as an example, the downlink signal from the core network equipment 50 is transmitted to the NTN gateway 30, the NTN gateway 30 forwards the downlink signal to the satellite 20, and the satellite 20 then forwards the downlink signal to the terminal device 10.

In the network architecture shown in FIGS. 1 and 2, the access network device 40 is a device configured to provide wireless communication services to the terminal device 10. The connection is established between the access network device 40 and the terminal device 10 such that the communication, including signaling and data interaction, is performed over the connection. A plurality of access network devices 40 may be deployed, and the communication between two neighboring access network devices 40 is performed wiredly or wirelessly. The terminal device 10 is switched between different access network devices 40, that is, establishes connections with different access network devices 40.

Taking the cellular communication network as an example, the access network device 40 in the cellular communication network is a base station. The base station is a device arranged in an access network for providing wireless communication functions for the terminal device 10. The base station includes various forms of macro base stations, micro base stations, relay stations, access points, and the like. In systems employing different radio access technologies, a device with a function of the access network device may have different names, for example, gNodeB or gNB in a 5G NR system. As a communication technology evolves, the name “base station” may change. For convenience of description, in the embodiments of the present disclosure, apparatuses providing the wireless communication function for the terminal device 10 are collectively referred to as the access network device.

In addition, the terminal device 10 in the embodiments of the present disclosure includes a handheld device with a wireless communication function, a vehicle-mounted device, a wearable device, a computing device or another processing device connected to a wireless modem, and various forms of user equipments (UEs), mobile stations (MS), terminal devices, and the like. For convenience of description, in the embodiments of the present disclosure, the devices are collectively referred to as terminal devices. In the embodiments of the present disclosure, “UE” is used in some places to represent “terminal device.” In the embodiments of the present disclosure, the “network device” may be an access network equipment (such as a base station) or a satellite.

In addition, taking a 5G NTN network as an example, the NTN network includes a plurality of satellites 20, and the satellite 20 covers a specific range of ground area to provide wireless communication services for the terminal device 10 on the ground area. In addition, the satellite 20 moves around the Earth in orbit. By arranging the plurality of satellites 20, communication coverage of different regions on the Earth's surface is realized.

In addition, in the embodiments of the present disclosure, the terms “network” and “system” are often used interchangeably, but those skilled in the art can understand their meanings. The technical solutions described in the embodiments of the present disclosure are applicable to a long-term evolution (LTE) system, a 5G NR system, a subsequent evolutionary system of the 5G NR system, or other communication systems, which is not limited in the present disclosure.

Prior to introducing the technical solutions of the present disclosure, some background technical knowledge involved in the present disclosure is introduced and explained. The following related art can be arbitrarily combined with the technical solutions of the embodiments of the present disclosure as optional solutions, and all of the technical solutions fall within the scope of protection of the embodiments of the present disclosure. The embodiments of the present disclosure include at least some of the following contents.

### Radio Resource Control (RRC) State in NR System

With the pursuit of speed, latency, high-speed mobility, energy efficiency, and the diversity and complexity of future services, the 3rd generation partner project (3GPP) international standards organization has begun to develop 5G. 5G's main application scenarios are: enhanced mobile broadband (eMBB), ultra-reliable low-latency broadband (URLLC), and massive machine-type communications (mMTC).

A new RRC state, i.e., the RRC_INACTIVE (RRC inactive) state, is defined in the 5G network environment for the purpose of reducing the air-port signaling, quickly restoring wireless connectivity and fast resumption of data services. This state is distinct from the RRC_IDLE (RRC idle) and RRC_CONNECTED (RRC connected) states.

RRC_IDLE (referred to as “IDLE state” or “Idle state”): The mobility is based on UE-based cell selection reselection, paging is initiated by the core network (CN), and the paging region is configured by the CN. A UE access stratum (AS) context is not present on the BTS, and the RRC connection is not present.

RRC_CONNECTED (referred to as “CONNECTED state” or “connected state”): The RRC connection is present and the UE AS context is present at the base station and the UE. The network side knows the location of the UE at the specific cell level. The mobility is a mobility controlled by the network side. The unicast data is transmitted between the UE and the base station.

RRC_INACTIVE (referred to as “INACTIVE state” or “inactive state”): The mobility is based on UE-based cell selection reselection, and a connection between the core network and the RAN is present. The UE AS context is present on the anchor base station, paging is triggered by the RAN, the RAN-based paging region is managed by the RAN, and the network side knows the location of the UE at the RAN-based paging region level.

### Radio Resource Management (RRM) Measurement of UE in Unconnected State of Narrow Band Internet of Things (NB-IoT)

The UE in the unconnected state needs to perform RRM measurement for the serving cell and other neighboring cells based on the network configuration to support mobility operations such as cell reselection.

The UE in the unconnected state performs measurement for the serving cell continuously. In the NB-IoT of related art, a neighboring cell measurement relaxation mechanism for stationary UEs is introduced to further satisfy the UE power saving requirements. The measurement relaxation criterion is introduced for neighboring cell measurement relaxation, and the network configures the evaluation time duration TSearchDeltaP of narrowband reference signal received quality (NRSRP) variation and change value threshold SSearchDeltaP of reference signal received power (RSRP). In the case that the amount of RSRP change on the serving cell of the UE over a period of time TSearchDeltaP is less than SSearchDeltaP, the UE is considered to satisfy the measurement relaxation criterion. That is, within a period of time TSearchDeltaP, the UE satisfies:

(SrxlevRef−Srxlev)<SSearchDeltaP <1>

Srxlev represents the current Srxlev measurement value of the serving cell, and SrxlevRef represents the reference Srxlev value of the serving cell.

In the case that the UE selects or reselects to a new cell, or in the case that (Srxlev−SrxlevRef)>0, or in the case that the UE does not satisfy Equation <1> in the duration TSearchDeltaP time:

the UE sets SrxlevRef to the current Srxlev measurement of the serving cell.

The UE is required to perform normal RRM measurement for at least a period of time TSearchDeltaP upon completing cell selection or reselection.

In the case that the UE satisfies the measurement relaxation criterion, the measurement interval of the UE for neighboring cells can be increased to 24 hours.

### RRM Measurement for NB-IoT UEs in Connected State

In related art, NB-IoT UEs do not support RRM measurement in the connected state. In the case that the channel quality of the NB-IoT UE in a connected state deteriorates on the serving cell, the mobility management is performed through the radio link failure (RLF) and RRC reconstruction process. Upon triggering RLF, the UE needs to select a suitable cell by searching and measuring first, and the RRC connection reconstruction is initiated on the selected cell.

In order to save the time for selecting a reconstructed cell upon the UE triggering the RLF, the related art introduces a neighboring cell measurement mechanism for UEs in the connected state. For the neighboring cell measurement of UEs in the connected state, the network configures the s-measure criterion over system messages, and also configures the UE mobility state evaluation criterion. Based on the s-measure criterion and the UE mobility state evaluation criterion, the UE determines whether it is necessary to perform the neighboring cell measurement. The method is as follows.

In the case that the UE enters the RRC connected state, and the UE mobility state assessment criterion is configured in the network, the NRSRP Ref is set to the most recently measured NRSRP on the serving cell used for cell selection or reselection.

In the case that the UE does not satisfy the neighboring cell measurement relaxation criterion prior to entering the RRC connected state, the UE starts the T326 timer.

For the UE in the connected state, assuming that the measurement result of the UE on the measured carrier is NRSRP.

In the case that the UE mobility state evaluation criterion is configured in the network,

in response to (NRSRP Ref−NRSRP−PowerOffsetNonAnchor)>s-MeasureDeltaP, the UE sets NRSRP Ref=NRSRP−PowerOffsetNonAnchor, and the UE starts or restarts the T326 timer simultaneously.

In the case that the UE mobility state evaluation criterion is not configured in the network or the T326 timer is running,

in response to (NRSRP−PowerOffsetNonAnchor)<s-MeasureIntra, the UE performs measurement on the same frequency neighboring cells; and in response to (NRSRP-PowerOffsetNonAnchor)<s-MeasureInter, the UE performs measurement on the heterodyne neighboring cells.

### Unconnected Measurement Control Introduced by NR NTN for Earth-Fixed Cell

In an NR NTN, in the case that the serving cell belongs to the quasi-Earth-fixed cell scenario, a neighboring cell measurement start mechanism based on location information and time information is introduced. Specifically, the neighboring cell measurement start mechanism based on location information introduces the distance Thresh parameter, and in the case that the distance between the UE and the serving cell reference point (e.g., the center of the cell) is less than distance Thresh, the UE stops the neighboring cell measurement, otherwise the UE performs the neighboring cell measurement. The neighboring cell measurement start mechanism based on time information introduces t-Service, which represents the time when the serving cell stops the service. In the case that the parameter is configured in the network, the UE needs to start performing the neighboring cell measurement on the same or different frequencies or different systems prior to start of the t-Service, no matter whether the location or RSRP/reference signal received quality (RSRQ) satisfies the corresponding start condition.

In the NR NTN, in the quasi-Earth-fixed cell scenario, the network may configure a relatively fixed cell reference point (e.g., the center point of the cell coverage) and a fixed cell service termination time in a system message, because the coverage of the NTN cell is stationary relative to the ground in a period of time. However, in an Earth-moving cell scenario, the coverage of the NTN cell is always moving relative to the ground as the satellite moves, and its ground reference point (i.e., the center point of the cell) is also moving along with the satellite, such that the complexity of configuring the center point of the cell in the system message is increased, and hence time-varying characteristics thereof need to be considered. Then, the stop-service time of the Earth-moving cell is no longer a uniform time, but varies for different geographical locations, and the system message is broadcast for all UEs in the cell. Therefore, it is impossible to simply configure different stop-service times for different locations. The present disclosure aims to research the neighboring cell measurement start mechanism in the Earth-moving cell scenario, which is applicable to NR NTNs and IoT NTNs, and UEs in a connected, idle or inactive state.

Hereinafter, the technical solutions according to the present disclosure are to be described and illustrated through several embodiments.

Referring to FIG. 3, FIG. 3 illustrates a flowchart of a method for neighboring cell measurement according to some embodiments of the present disclosure. The method is applicable to any of the satellite network architectures shown in FIG. 1 or FIG. 2, e.g., the method is performed by a terminal device. The method includes the following processes.

In 310, in response to the terminal device satisfying a neighboring cell measurement start condition, the terminal device starts or performs a neighboring cell measurement; wherein the neighboring cell measurement start condition is related to first information and/or second information, the first information including information related to a distance and/or a delay between the terminal device and a satellite, and the second information including information related to a measurement start time. The information related to the distance between the terminal device and the satellite is understood as information related to the position, i.e., information related to the position of the terminal device and the position of the satellite.

The neighboring cell measurement start condition is a condition configured to trigger starting or performing the neighboring cell measurement. In the case that the terminal device satisfies the neighboring cell measurement start condition, the terminal device starts or performs the measurement on the neighboring cell. Starting the measurement is understood as starting to perform a measurement process to the neighboring cell.

The satellite network architecture in which the terminal device is located is an architecture of transparent payload as shown in FIG. 1 or an architecture of regenerative payload as shown in FIG. 2, which is not limited in the present disclosure.

In the case that the neighboring cell measurement start condition is related to the first information, and the first information includes information related to the distance and/or delay between the terminal device and the satellite, the neighboring cell measurement initiation control scheme according to the embodiments of the present disclosure is understood as a location-based or delay-based neighboring cell measurement start mechanism. In the case that the neighboring cell measurement start condition is related to the second information and the second information includes information related to the measurement start time, the neighboring cell measurement start control scheme according to the embodiments of the present disclosure is understood as a neighboring cell measurement start mechanism based on time information.

In some embodiments, the first information includes at least one of: an elevation angle between the terminal device and the satellite; a distance between the terminal device and the satellite; a propagation delay from the terminal device to the satellite; or a timing advance (TA) of the terminal device.

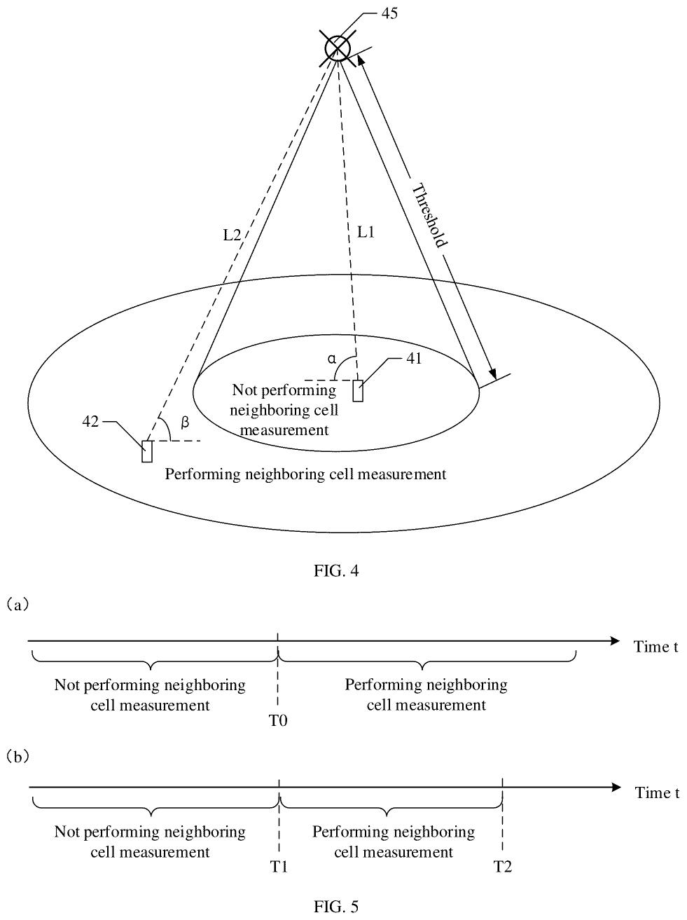

The elevation angle between the terminal device and the satellite is the angle between the line connecting the terminal device to the satellite and the horizontal plane. Exemplarily, as shown in FIG. 4, the elevation angle between the terminal device 41 and the satellite 45 is α, and the elevation angle between the terminal device 42 and the satellite 45 is β. The elevation angle between the terminal device and the satellite may reflect the distance between the terminal device and the satellite. Generally, the smaller the elevation angle between the terminal device and the satellite, the greater the distance between the terminal device and the satellite. Conversely, the greater the elevation angle between the terminal device and the satellite, the smaller the distance between the terminal device and the satellite. Exemplarily, as shown in FIG. 4, α>β, L1<L2, wherein L1 represents a distance between the terminal device 41 and the satellite 45, and L2 represents a distance between the terminal device 42 and the satellite 45.

The distance between the terminal device and the satellite is a length of a line connecting the terminal device to the satellite. Exemplarily, as shown in FIG. 4, L1 denotes the distance between the terminal device 41 and the satellite 45, and L2 denotes the distance between the terminal device 42 and the satellite 45, and as can be seen from FIG. 4, L1<L2.

The propagation delay from the terminal device to the satellite is a one-way propagation delay or a two-way propagation delay. The one-way propagation delay is the length of time when the information is transmitted from the terminal device to the time when the satellite receives the information. Alternatively, the one-way propagation delay is the length of time when the information is transmitted from the satellite to the time when the terminal device receives the information. The two-way propagation delay is the sum of the length of time when the information is transmitted from the terminal device to the time when the satellite receives the information, and the length of time the information is transmitted from the satellite to the time when the terminal device receives the information. The propagation delay from the terminal device to the satellite can reflect the distance between the terminal device and the satellite. Generally, the greater the propagation delay from the terminal device to the satellite, the greater the distance between the terminal device and the satellite. Conversely, the smaller the propagation delay from the terminal device to the satellite, the smaller the distance between the terminal device and the satellite.

The TA of the terminal device also reflects the distance and/or delay between the terminal device and the satellite. Generally, the greater the TA of the terminal device, the greater the distance and/or time delay between the terminal device and the satellite. Conversely, the smaller the TA of the terminal device, the smaller the distance and/or time delay between the terminal device and the satellite. The TA of the terminal device is the current actual TA of the terminal device, and the terminal device in the connected state acquires the current actual TA by open-loop and/or closed-loop control. It should be noted that, for the architecture of transparent payload shown in FIG. 1, the TA of the terminal device actually reflects the propagation delay from the terminal device to the access network device. But because the communication between the terminal device and the access network device is relayed by the satellite, the TA of the terminal device can also reflect the delay and/or distance between the terminal device and the satellite to a certain extent. For the architecture of regenerative payload shown in FIG. 2, because the access network device is not present, the TA of the terminal device actually reflects the propagation delay from the terminal device to the satellite, i.e., the TA is able to reflect the delay and/or distance between the terminal device and the satellite.

In some embodiments, the neighboring cell measurement start condition includes at least one of: the elevation angle being less than or equal to a first threshold, wherein the first threshold is exemplarily noted as alpha-threshold; the distance being greater than or equal to a second threshold, wherein the second threshold is exemplarily noted as d-threshold; the propagation delay being greater than or equal to a third threshold, wherein the third threshold is exemplarily noted as a t-threshold; or the TA being greater than or equal to a fourth threshold, wherein the fourth threshold is exemplarily noted as a TA-threshold.

In the case that the elevation angle between the terminal device and the satellite is less than or equal to the first threshold, the distance between the terminal device and the satellite of the current serving cell is greater, and thus the terminal device is triggered to start or perform the measurement on the neighboring cell.

In the case that the distance between the terminal device and the satellite is greater than or equal to the second threshold, the distance between the terminal device and the satellite of the current serving cell is greater, and thus the terminal device is triggered to start or perform the measurement on the neighboring cell.

In the case that the propagation delay from the terminal device to the satellite is greater than or equal to the third threshold, the distance between the terminal device and the satellite of the current serving cell is greater, and thus the terminal device is triggered to start or perform the measurement on the neighboring cell.

In the case that the TA of the terminal device is greater than or equal to the fourth threshold, the distance between the terminal device and the satellite of the current serving cell is greater, and thus the terminal device is triggered to start or perform the measurement on the neighboring cell.

It should be noted that the first information corresponds to the neighboring cell measurement start condition. In the case that the first information includes the elevation angle between the terminal device to the satellite, the neighboring cell measurement start condition includes the elevation angle being less than or equal to the first threshold. In the case that the first information includes the distance between the terminal device and the satellite, the neighboring cell measurement start condition includes the distance being greater than or equal to the second threshold. In the case that the first information includes the propagation delay from the terminal device to the satellite, the neighboring cell measurement start condition includes the propagation delay being greater than or equal to the third threshold. In the case that the first information includes the TA of the terminal device, the neighboring cell measurement start condition includes the TA being greater than or equal to the fourth threshold. Alternatively, the first information includes any one or a combination of one or more of the elevation angle, the distance, the propagation delay, or the TA. Accordingly, the neighboring cell measurement start condition also includes any one or a combination of one or more of a) to d) above.

In some embodiments, the terminal device determines a position of the terminal device based on the location information, determines a position of the satellite based on the ephemeris information broadcast by the serving cell, and determines at least one of the elevation angle, the distance, or the propagation delay based on the position of the terminal device and the position of the satellite. The location information is global navigation satellite system (GNSS) positioning information, or other types of positioning information, which is not limited in the present disclosure. Upon determination of the position of the terminal device and the position of the satellite, the distance between the terminal device and the satellite may be calculated, or the elevation angle may be determined based on the angle between the line connecting the terminal device to the satellite and the horizontal plane, or the distance may be divided by the speed of light to acquire the one-way propagation delay from the terminal device to the satellite.

In some embodiments, the second information includes at least one of a start time of the measurement, or an end time of the measurement.

The start time of the measurement is a start time of the terminal device starting or performing the measurement on the neighboring cell, and the end time of the measurement is a time of the terminal device stopping or ending the measurement on the neighboring cell. The second information includes only the start time of the measurement, includes only the end time of the measurement, or includes both the start time and the end time of the measurement.

In some embodiments, in the case that the second information includes the start time and the end time of the measurement, the second information essentially specifies a time window of the measurement that includes the start time and the end time of the measurement. For example, the time window of the measurement is a time interval starting from the start time of the measurement and ending at the end time of the measurement. For example, the time window of the measurement is denoted as [T1, T2], with T1 denoting the start time of the measurement and T2 denoting the end time of the measurement.

In some embodiments, the neighboring cell measurement start condition includes at least one of: the current time being greater than or equal to the start time of the measurement; or the current time being less than or equal to the end time of the measurement.

In the case that the current time is greater than or equal to the start time of the measurement, the neighboring cell measurement start condition is satisfied, and the terminal device starts or performs the measurement on the neighboring cell.

In the case that the current time is less than or equal to the end time of the measurement, the neighboring cell measurement start condition is satisfied, and the terminal device starts or performs the measurement on the neighboring cell.

In the case that the current time is greater than or equal to the start time of the measurement and the current time is less than or equal to the end time of the measurement, the neighboring cell measurement starting condition is satisfied, and the terminal device starts or performs the measurement on the neighboring cell.

It should be noted that the second information corresponds to the neighboring cell measurement start condition. In the case that the second information includes the start time of the measurement, the neighboring cell measurement starting condition includes the current time being greater than or equal to the start time of the measurement. In the case that the second information includes the end time of the measurement, the neighboring cell measurement starting condition includes the current time being less than or equal to the end time of the measurement.

Exemplarily, as shown in part (a) of FIG. 5, in the case that the second information includes a start time T0 of the measurement, and the neighboring cell measurement start condition includes the current time being greater than or equal to the start time T0 of the measurement, the terminal device does not perform the neighboring cell measurement until the start time T0, and the terminal device performs the neighboring cell measurement from the start time T0.

Exemplarily, as shown in part (b) of FIG. 5, in the case that the second information includes a time window [T1, T2] of the measurement, and the neighboring cell measurement start condition includes that the current time is within the time window, the terminal device does not perform the neighboring cell measurement until the time T1, and from the time T1 to the time T2, the terminal device performs the measurement on the neighboring cell, and the terminal device ends the measurement on the neighboring cell at the time T2.

In some embodiments, the start time of the measurement is: the time when the serving cell starts to be overlapped with a neighboring cell nearest to the terminal device; or the time when the serving cell starts to be overlapped with a neighboring cell nearest to the terminal device at a target frequency point; or the time when the serving cell starts to be overlapped with a target neighboring cell start.

In the case that the configuration information related to the neighboring cell measurement start condition is configured for each terminal device, the start time of the measurement is the time when the serving cell starts to be overlapped with the neighboring cell nearest to the terminal device. In the case that the configuration information related to the neighboring cell measurement start condition is configured for each frequency point, the start time of the measurement is the time when the serving cell starts to be overlapped with the neighboring cell nearest to the terminal device at the target frequency point; wherein the target frequency point is any frequency point. In the case that the configuration information related to the neighboring cell measurement start condition is configured for each neighboring cell, the start time of the measurement is the time when the serving cell starts to be overlapped with the target neighboring cell, wherein the target neighboring cell is any one of the neighboring cells.

In addition, in some embodiments of the present disclosure, the way that the terminal device acquires the current time is not limited. For example, the terminal device acquires the current time through a GNSS or by reading a system information block (SIB) 9 message.

In some embodiments, the terminal device receives configuration information from the serving cell, the configuration information indicates a parameter related to the neighboring cell measurement start condition.

Exemplarily, in the case that the neighboring cell measurement start condition includes at least one of: a) the elevation angle being less than or equal to the first threshold; b) the distance being greater than or equal to the second threshold; c) the propagation delay being greater than or equal to the third threshold; or d) the TA being greater than or equal to the fourth threshold, accordingly, the configuration information includes at least one of a) the first threshold, b) the second threshold, c) the third threshold, or d) the fourth threshold.

Exemplarily, in the case that the neighboring cell measurement start condition includes at least one of: 1) the current time being greater than or equal to the start time of the measurement; or 2) the current time being less than or equal to the end time of the measurement, accordingly, the configuration information includes at least one of 1) the start time of the measurement, or 2) the end time of the measurement.

In some embodiments, the configuration information is configured for each terminal device, or for each frequency point, or for each neighboring cell. That is, the configuration information is configured based on requirements in conjunction with the actual needs, thereby enhancing the flexibility of the configuration of the neighboring cell measurement start condition.

In some embodiments, the configuration information is transmitted over a system message, or over RRC dedicated signaling. Exemplarily, the system message is a SIB 1 message, a SIB 2 message, a SIB 19 message, and the like. Exemplarily, the RRC dedicated signaling is an RRC reconfiguration message.

In some embodiments, different types of neighboring cells correspond to the same neighboring cell measurement start conditions. The different types of neighboring cells include at least two of intra-frequency neighboring cells, inter-frequency neighboring cells, and inter-system neighboring cells. For example, the intra-frequency neighboring cell, the inter-frequency neighboring cell, and the inter-system neighboring cell correspond to the same neighboring cell measurement start condition. In the case that the terminal device satisfies this neighboring cell measurement start condition, the terminal device starts or performs measurement on the intra-frequency neighboring cell, the inter-frequency neighboring cell, and the inter-system neighboring cell.

In some embodiments, different types of neighboring cells correspond to different neighboring cell measurement start conditions. The different types of neighboring cells include at least two of intra-frequency neighboring cells, inter-frequency neighboring cells, and inter-system neighboring cells. For example, the intra-frequency neighboring cell, the inter-frequency neighboring cell, and the inter-system neighboring cell correspond to different neighboring cell measurement start conditions. In the case that the terminal device satisfies the neighboring cell measurement start condition corresponding to the intra-frequency neighboring cell, the terminal device starts or performs the measurement on the intra-frequency neighboring cell. In the case that the terminal device satisfies the neighboring cell measurement start condition corresponding to the inter-frequency neighboring cell, the terminal device starts or performs the measurement on the inter-frequency neighboring cell. In the case that the terminal device satisfies the neighboring cell measurement start condition corresponding to the inter-system neighboring cell, the terminal device starts or performs the measurement on the inter-system neighboring cell. In this way, different neighboring cell measurement start conditions are configured for different types of neighboring cells, such as setting different neighboring cell measurement start conditions according to the deployment of different types of neighboring cells, thereby providing more flexibility and helping to avoid the terminal device from performing some unnecessary neighboring cell measurement and saving power consumption.

In some embodiments, in response to the terminal device not satisfying the neighboring cell measurement start condition, the terminal device does not perform the process of starting or performing the measurement on the neighboring cell, i.e., the terminal device does not start or perform the measurement on the neighboring cell.

In some embodiments, the neighboring cell measurement method according to some embodiments of the present disclosure is applicable to a scenario that the terminal device and the satellite are in an Earth-moving cell.

In some embodiments, the neighboring cell measurement method according to some embodiments of the present disclosure is applicable to a scenario that the terminal device is in an idle state, or an inactive state, or a connected state.

In some embodiments, in the case that the signal quality of the serving cell is greater than or equal to the fifth threshold and the terminal device satisfies the neighboring cell measurement start condition, the terminal device starts or performs the measurement on the neighboring cell. Alternatively, in the case that the signal quality of the serving cell is greater than or equal to the fifth threshold and the terminal device does not satisfy the neighboring cell measurement start condition, the terminal device does not perform the process of starting or performing the measurement on the neighboring cell, i.e., the terminal device does not start or perform the measurement on the neighboring cell. Exemplarily, the signal quality described above includes RSRP and/or RSRQ.

Exemplarily, in the case that both the RSRP and RSRQ measurement results of the serving cell are greater than or equal to the RSRP threshold and RSRQ threshold configured by the network:

in the case that the network is configured with the parameters related to the neighboring cell measurement start conditions, the terminal device supports the neighboring cell measurement start mechanism, and the terminal device has available or valid location information that includes information for determining determine the location of the terminal device e.g., GNSS information), and optionally information for determining the location of satellites (e.g., ephemeris information provided by the serving cell);

in response to the terminal device satisfying the neighboring cell measurement start condition, the terminal device starts or performs the measurement on the neighboring cell;

otherwise (i.e., in response to the terminal device not satisfying the neighboring cell measurement start conditions), the terminal device does not start or perform the measurement on the neighboring cell;

otherwise (i.e., the network is not configured with the parameters related to the neighboring cell measurement start conditions; and/or the terminal device does not support the neighboring cell measurement start mechanism; and/or the terminal device does not have available or valid location information), the terminal device does not start or perform the measurement on the neighboring cell;

otherwise (i.e., the RSRP measurement result of the serving cell is less than the RSRP threshold; and/or the RSRQ measurement result of the serving cell is less than the RSRQ threshold), the terminal device starts or performs the measurement on the neighboring cell.

In summary, the technical solution according to some embodiments of the present disclosure provides the method for controlling a terminal device to perform a neighboring cell measurement in an NTN, a neighboring cell measurement start condition based on the distance and/or the delay between the terminal device and the satellite and/or a measurement start time is introduced, such that the terminal device starts the neighboring cell measurement in the case that the terminal device is about to leave the current serving cell and arrive a neighboring cell, thereby enabling the terminal device to find a target cell for cell reselection or handover as soon as possible, and improving the communication reliability.

Hereinafter are embodiments of the present disclosure illustrating an apparatus for neighboring cell measurement. The apparatus is configured to implement the method embodiments of the present disclosure. The details not disclosed in the apparatus embodiments of the present disclosure are referred to the method embodiments of the present disclosure.

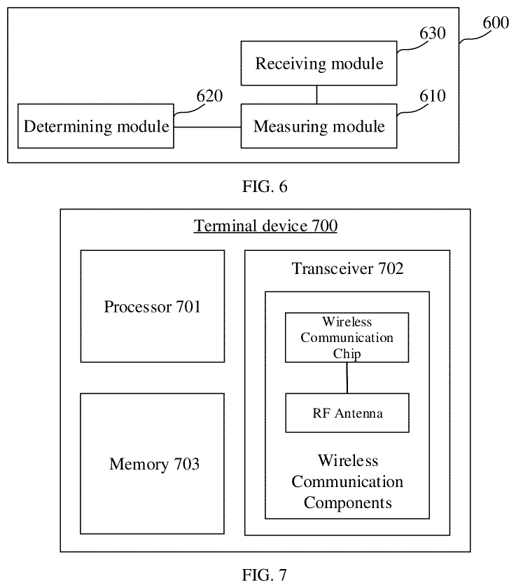

Referring to FIG. 6, FIG. 6 illustrates a block diagram of an apparatus for neighboring cell measurement according to some embodiments of the present disclosure. The apparatus has a function for implementing the method embodiments and the function is realized by hardware or by hardware executing corresponding software. The apparatus is a terminal device as described above, or is provided in a terminal device. As shown in FIG. 6, the apparatus 600 includes a measuring module 610.

The measuring module 610 is configured to start or perform measurement on a neighboring cell in response to the terminal device satisfying a neighboring cell measurement start condition; wherein the neighboring cell measurement start condition is related to first information and/or second information, the first information including information related to a distance and/or delay between the terminal device and a satellite, and the second information including information related to a measurement start time.

In some embodiments, the first information includes at least one of: an elevation angle between the terminal device and the satellite; a distance between the terminal device and the satellite; a propagation delay from the terminal device to the satellite; or a TA of the terminal device.

In some embodiments, the neighboring cell measurement start condition includes at least one of: the elevation angle being less than or equal to a first threshold; the distance being greater than or equal to a second threshold; the propagation delay being greater than or equal to a third threshold; or the TA being greater than or equal to a fourth threshold.

In some embodiments, as shown in FIG. 6, the apparatus 600 further includes a determining module 620, configured to determine a position of the terminal device based on location information; determine a position of the satellite based on ephemeris information broadcast by a serving cell; and determine at least one of the elevation angle, the distance, or the propagation delay based on the position of the terminal device and the position of the satellite.

In some embodiments, the second information includes at least one of a start time of the measurement or an end time of the measurement.

In some embodiments, the neighboring cell measurement start condition includes at least one of: a current time being greater than or equal to the start time of the measurement; or a current time being less than or equal to the end time of the measurement.

In some embodiments, the start time of the measurement is: a time when a serving cell starts to be overlapped with a neighboring cell nearest to the terminal device; or a time when a serving cell starts to be overlapped with a neighboring cell nearest to the terminal device at a target frequency point; or a time when a serving cell starts to be overlapped with a target neighboring cell.

In some embodiments, as shown in FIG. 6, the apparatus 600 further includes: a receiving module 630, configured to receive configuration information transmitted by a serving cell, wherein the configuration information indicates a parameter related to the neighboring cell measurement start condition.

In some embodiments, the configuration information is configured for each terminal device, or for each frequency point, or for each neighboring cell.

In some embodiments, the configuration information is transmitted over a system message, or over RRC dedicated signaling.

In some embodiments, different types of neighboring cells correspond to the same neighboring cell measurement start condition; or different types of neighboring cells correspond to different neighboring cell measurement start conditions; wherein the different types of the neighboring cells include at least two of intra-frequency neighboring cells, inter-frequency neighboring cells, and inter-system neighboring cells.

In some embodiments, the measuring module 610 is further configured to not start or perform the measurement on the neighboring cell in response to the terminal device not satisfying the neighboring cell measurement start condition.

In some embodiments, the measuring module 610 is further configured to: start or perform the measurement on the neighboring cell in response to a signal quality of a serving cell being greater than or equal to a fifth threshold and the terminal device satisfying the neighboring cell measurement start condition; or not start or perform the measurement on the neighboring cell in response to the signal quality of the serving cell being greater than or equal to the fifth threshold and the terminal device not satisfying the neighboring cell measurement start condition.

In some embodiments, the terminal device and the satellite are in an Earth-moving cell scenario.

In some embodiments, the terminal device is in an idle, inactive, or connected state.

The present disclosure provides a method for controlling a terminal device to perform a neighboring cell measurement in an NTN, a neighboring cell measurement start condition based on the distance and/or the delay between the terminal device and the satellite and/or a measurement start time is introduced, such that the terminal device starts the neighboring cell measurement in the case that the terminal device is about to leave the current serving cell and arrive a neighboring cell, thereby enabling the terminal device to find a target cell for cell reselection or handover as soon as possible, and improving the communication reliability.

It should be noted that in the case that the apparatus provided in the foregoing embodiments performs its functions, division of the functional modules is merely used as an example. In practice, the foregoing functions may be allocated to and completed by different functional modules as required, that is, an internal structure of the apparatus is divided into different functional modules to complete all or some of the foregoing functions.

Specific manners of performing operations by the modules in the apparatus in the foregoing embodiments have been described in detail in the embodiments of the related method, which are not described herein any further.

Referring to FIG. 7, FIG. 7, illustrates a schematic structure of a terminal device 700 according to some embodiments of the present disclosure. The terminal device 700 is configured to perform the method processes in the method embodiments. The terminal device 700 includes a processor 701, a transceiver 702, and a memory 703.

The processor 701 includes one or more processing cores. The processor 701 runs a software program and module to execute various functional applications.

The transceiver 702 includes a receiver and a transmitter. For example, the receiver and the transmitter are implemented as the same wireless communication component, and the wireless communication component includes a wireless communication chip and an RF antenna.

The memory 703 is coupled to the processor 701 and the transceiver 702.

The memory 703 is configured to store a computer program executed by the processor, and the processor 701 is configured to run the computer program to implement the various processes performed by the terminal device in the method embodiments described above.

In addition, the memory 703 is implemented by any type of volatile or non-volatile storage device or a combination thereof, volatile or non-volatile storage devices include, but are not limited to: disks or optical disks, electrically erasable programmable read-only memories, erasable programmable read-only memories, static ready-to-access memories, read-only memories, magnetic memories, flash memories, and programmable read-only memories.

In some embodiments, the processor 701 is configured to start or perform measurement on a neighboring cell in response to the terminal device satisfying a neighboring cell measurement start condition; the neighboring cell measurement start condition is related to first information and/or second information, the first information including information related to a distance and/or delay between the terminal device and a satellite, and the second information including information related to a measurement start time.

For details not described in detail in the apparatus embodiments, reference may be made to the introductory description in the method embodiments, which are not repeated herein.

Embodiments of the present disclosure also provide a computer-readable storage medium, the storage medium stores at least one computer program, wherein a processor, when loading and executing the at least one computer program, is caused to perform the method for neighboring cell measurement on the terminal device side.

Optionally, the computer-readable storage medium includes: a read-only memory (ROM), a random-access memory (RAM), a solid state drives (SSD), or a CD-ROM. The random access memory includes a resistance random access memory (ReRAM) or a dynamic random access memory (DRAM).

Embodiments of the present disclosure also provide a chip, the chip includes at least one programmable logic circuit and/or program instruction, wherein the chip, when running on a terminal device, performs the method for neighboring cell measurement.

Embodiments of the present disclosure also provide a computer program product, the computer program product includes at least one computer instruction, and at least one computer instruction, when loaded and executed by a processor, causes the processor to perform the method for neighboring cell measurement.

It is understandable that the term “indicate” in the embodiments of the present disclosure means a direct indication, an indirect indication, or an associated relationship. For example, A indicating B, which mean that A indicates B directly, e.g., B is acquired by A; or that A indicates B indirectly, e.g., A indicates C, wherein B is acquired by C; or that an association relationship is present between A and B.

In the description of embodiments of the present disclosure, the term “corresponding” indicates a direct or indirect corresponding relationship between the two, or an association relationship between the two, or a relationship between instructing and being instructed, configuring and being configured, and the like.

In some embodiments of the present disclosure, “predefined” is realized by storing a corresponding code, form or other manners that can be used to indicate relevant information in advance in a device (for example, including a terminal device and a network device), and the present disclosure does not limit the specific implementation thereof. For example, predefined may indicate defined in a protocol.

In some embodiments of the present disclosure, the “protocols” indicate standard protocols in the field of communications. For example, the protocols include the LTE protocols, the NR protocols, and related protocols applied to the future communication system, which are not limited in the present disclosure.

References to “a plurality of” in the disclosure means two or more. The term “and/or” indicates an association relationship describing associated objects, that is, three types of relationships. For example, the phrase “A and/or B” indicates (A), (B), or (A and B). The character “/” generally indicates an “or” relationship between the associated objects.

In addition, the number of the process described herein only exemplarily shows a possible sequence of execution among the processes, and in some other embodiments, the processes may not be executed in accordance with the number order, such as two differently-numbered processes being executed at the same time, or two differently-numbered processes being executed in the opposite order to that shown in the drawings, which is not limited in the embodiments of the present disclosure.

It should be appreciated by those skilled in the art that the functions described in the embodiments of the present disclosure in one or more of the above-described examples may be implemented using hardware, software, firmware, or any combination thereof. When implementing by software, the functions may be stored in a computer-readable medium or transmitted as one or more instructions or code on the computer-readable medium. Computer-readable media include computer storage media and communication media, wherein communication media include any medium that facilitates the transmission of a computer program from one location to another. The storage medium may be any available medium to which a general purpose or specialized computer has access.

Described above are merely exemplary embodiments of the present disclosure and are not intended to limit the present disclosure. Any modification, equivalent replacement, and improvement within the spirit and principle of the present disclosure shall be included within the protection scope of the present disclosure.

1. A method for neighboring cell measurement, applicable to a terminal device, the method comprising:
starting or performing measurement on a neighboring cell in response to the terminal device satisfying a neighboring cell measurement start condition;
wherein the neighboring cell measurement start condition is related to at least one of first information or second information, the first information comprising information related to at least one of a distance or delay between the terminal device and a satellite, and the second information comprising information related to a measurement start time.

2. The method according to claim 1, wherein the first information comprises at least one of:
an elevation angle between the terminal device and the satellite;
a distance between the terminal device and the satellite;
a propagation delay from the terminal device to the satellite; or
a timing advance (TA) of the terminal device.

3. The method according to claim 2, wherein the neighboring cell measurement start condition comprises at least one of:
the elevation angle being less than or equal to a first threshold;
the distance being greater than or equal to a second threshold;
the propagation delay being greater than or equal to a third threshold; or
the TA being greater than or equal to a fourth threshold.

4. The method according to claim 2, further comprising:
determining a position of the terminal device based on location information;
determining a position of the satellite based on ephemeris information broadcast by a serving cell; and
determining at least one of the elevation angle, the distance, or the propagation delay based on the position of the terminal device and the position of the satellite.

5. The method according to claim 1, wherein the second information comprises at least one of:
a start time of the measurement; or
an end time of the measurement.

6. The method according to claim 5, wherein the neighboring cell measurement start condition comprises at least one of:
a current time being greater than or equal to the start time of the measurement; or
a current time being less than or equal to the end time of the measurement.

7. The method according to claim 5, wherein the start time of the measurement is:
a time when a serving cell starts to be overlapped with a neighboring cell nearest to the terminal device; or
a time when a serving cell starts to be overlapped with a neighboring cell nearest to the terminal device at a target frequency point; or
a time when a serving cell starts to be overlapped with a target neighboring cell.

8. The method according to claim 1, further comprising:
receiving configuration information transmitted by a serving cell, wherein the configuration information indicates a parameter related to the neighboring cell measurement start condition.

9. The method according to claim 8, wherein the configuration information is configured for each terminal device, or for each frequency point, or for each neighboring cell.

10. The method according to claim 8, wherein the configuration information is transmitted over a system message, or over radio resource control (RRC) dedicated signaling.

11. The method according to claim 1, wherein
different types of neighboring cells correspond to the same neighboring cell measurement start condition; or
different types of neighboring cells correspond to different neighboring cell measurement start conditions;
wherein the different types of the neighboring cells comprise at least two of intra-frequency neighboring cells, inter-frequency neighboring cells, and inter-system neighboring cells.

12. The method according to claim 1, further comprising:
not starting or performing the measurement on the neighboring cell in response to the terminal device not satisfying the neighboring cell measurement start condition.

13. The method according to claim 1, further comprising:
starting or performing the measurement on the neighboring cell in response to a signal quality of a serving cell being greater than or equal to a fifth threshold and the terminal device satisfying the neighboring cell measurement start condition; or
not starting or performing the measurement on the neighboring cell in response to the signal quality of the serving cell being greater than or equal to the fifth threshold and the terminal device not satisfying the neighboring cell measurement start condition.

14. The method according to claim 1, wherein the terminal device and the satellite are in an Earth-moving cell scenario.

15. The method according to claim 1, wherein the terminal device is in an idle state, or an inactive state, or a connected state.

16. A terminal device, comprising a processor and a memory, wherein the memory stores at least one computer program, and the processor, when loading and executing the at least one computer program, is caused to perform:
starting or performing measurement on a neighboring cell in response to the terminal device satisfying a neighboring cell measurement start condition;
wherein the neighboring cell measurement start condition is related to at least one of first information or second information, the first information comprising information related to at least one of a distance or delay between the terminal device and a satellite, and the second information comprising information related to a measurement start time.

17. The terminal device according to claim 16, wherein the first information comprises at least one of:
an elevation angle between the terminal device and the satellite;
a distance between the terminal device and the satellite;
a propagation delay from the terminal device to the satellite; or
a timing advance (TA) of the terminal device.

18. The terminal device according to claim 17, wherein the neighboring cell measurement start condition comprises at least one of:
the elevation angle being less than or equal to a first threshold;
the distance being greater than or equal to a second threshold;
the propagation delay being greater than or equal to a third threshold; or
the TA being greater than or equal to a fourth threshold.

19. The terminal device according to claim 17, wherein the processor, when loading and executing the at least one computer program, is caused to perform:
determining a position of the terminal device based on location information;
determining a position of the satellite based on ephemeris information broadcast by a serving cell; and
determining at least one of the elevation angle, the distance, or the propagation delay based on the position of the terminal device and the position of the satellite.

20. A chip, comprising at least one of at least one programmable logic circuit or at least one program instruction, wherein the chip, when running, is caused to perform:
starting or performing measurement on a neighboring cell in response to the terminal device satisfying a neighboring cell measurement start condition;
wherein the neighboring cell measurement start condition is related to at least one of first information or second information, the first information comprising information related to at least one of a distance or delay between the terminal device and a satellite, and the second information comprising information related to a measurement start time.
